(19) United States
(12) Patent Application Publication
(10) Pub. No.: US 2007/0208481 A1
(43) Pub. Date: Sep. 6, 2007

(54) Vehicle brake control device

(75) Inventors: Kazuya Maki, Nagoya-city (JP); Hiroaki Niino, Toyota-city (JP)

Correspondence Address: POSZ LAW GROUP, PLC, 12040 SOUTH LAKES DRIVE, SUITE 101, RESTON, VA, 20191, US

(73) Assignee: ADVICS CO., LTD., Kariya-city (JP)

(21) Appl. No.: 11/710,926

(22) Filed: Feb. 27, 2007

(30) Foreign Application Priority Data
Mar. 6, 2006 (JP) 2006-059422

(51) Int. Cl. G06G 7/76

(52) U.S. Cl. 701/70; 701/78

(57) ABSTRACT

A vehicle brake control device cuts off one or more of the first to fourth linear valves in order to prohibit completely supply of a current to the one or more of the first to fourth linear valves, in the case that a slip ratio of one or more wheels is larger than a first threshold. Thus, it is possible to avoid slow depressurization of the W/C pressure caused by the weak current. In other words, it is possible to achieve quick response in the W/C pressures which allows the depressurization to work well.

### CROSS REFERENCE TO RELATED APPLICATION

This application is based on and incorporates herein by reference Japanese patent application No. 2006-59422 filed on Mar. 6, 2006.

### FIELD OF THE INVENTION

The present invention relates to a vehicle brake control device which generates pressures (hereinafter referred to as W/C pressures) in wheel cylinders (hereinafter referred to as W/Cs) by causing pumps to apply pressures.

### BACKGROUND OF THE INVENTION

A conventional vehicle brake control device is proposed in Japanese Patent Publication No. H11-301435 which drives pumps by means of motors and generates W/C pressures at W/Cs for respective wheels by causing the pump to draw in and discharge brake fluid.

In the conventional vehicle brake control device, linear differential pressure valves are provided in conduit systems respectively connecting discharge ports of the pumps with a reservoir for supplying brake fluid. The W/C pressures are controlled by means of the linear differential pressure valves, respectively.

In performing an anti-lock brake control (hereinafter referred to an ABS control), the conventional vehicle brake control device changes differential pressures generated at the linear differential pressure valves by changing indication values for the differential pressures. For example, in the ABS control, the indication values are changed to 0 MPa so as to allow the W/C pressures escape into the reservoir.

However, the inventors of the present invention have found that depressurizing of the W/Cs cannot be sufficiently quick if the vehicle brake control device performs nothing more than changing the indication values to decrease the W/C pressures in the ABS control. This is supposed to come from a reason as follows.

When an indication value for a linear differential pressure valve becomes 0 MPa, a current value of an electrical current to be supplied to the linear differential pressure valve becomes, for example, 0.1 A. Thus, a characteristic of the linear differential pressure valve causes a weak current to be still supplied to the linear differential pressure valve even if the indication value is 0 MPa. The weak current slows down the depressurization of the W/C and therefore obstacles sufficiently quick depressurization of the linear differential pressure valves.

### SUMMARY OF THE INVENTION

It is therefore an object of the present invention to provide a vehicle brake control device which controls W/C pressures of wheels of a vehicle by means of linear valves and achieves quick depressurization of the linear valves required to achieve a proper ABS control.

In the vehicle brake control device of the present invention, a control means (100) includes: a first calculating portion for calculating target wheel cylinder pressures corresponding to the operation amount detected by the operation amount sensor when the operation amount sensor detects that the brake operating member is operated; a second calculating portion for calculating slip ratios of the front wheels and the rear wheels; and an adjusting portion for adjusting current values of currents to be supplied to the first to fourth linear valves based on results of calculations of the first and second calculating portions. In addition, the adjusting portion includes a current cutting means for executing a first current OFF control when one of the calculated slip ratios is larger than a first threshold value, the first current off control being for cutting off one of the currents for one of the first to fourth linear valves, the one linear valve corresponding to one of the front and rear wheels having the one slip ratio larger than the first threshold value.

Thus, the vehicle brake control device cuts off one or more of the first to fourth linear valves in order to prohibit completely supply of the current to the one or more of the first to fourth linear valves, in the case that a slip ratio corresponding to the one or more of the first to fourth liner valves is larger than the first threshold. Thus, it is possible to avoid slow depressurization of one or more of the W/C pressures caused by a weak current. In other words, it is possible to achieve quick response in one or more of the W/C pressures which allows the depressurization to work well.

The control means may include a third calculating portion for calculating increase rates of the slip ratios calculated by the second calculating portion. In this case, the current cutting means may execute a second current OFF control when one of the calculated increase rates is larger than a second threshold value, the second current off control being for cutting off one of the currents for one of the first to fourth linear valves, the one or more of the linear valves corresponding to one or more of the front and rear wheels having the one or more of the increase rates larger than the second threshold value.

The quick depressurization is also desired in the case that the one or more of the increase rates of the slip ratios is larger than the second threshold. Therefore, the vehicle brake control device may execute the second cut OFF control in this case.

The adjusting portion may perform after executing the first and/or second current OFF control: detecting wheel cylinder pressures of the first front wheel cylinder, the second front wheel cylinder, the first rear wheel cylinder, and the second rear wheel cylinder based on detection signals from pressure sensors (13 to 18) for detecting respectively the wheel cylinder pressures; and adjusting one or more of the current values for one or more of the linear valves which is under control of the first and/or second current OFF control, based on one of the detected wheel cylinder pressures corresponding to the one or more of the linear valves.

Thus, in supplying again the currents to one or more of the first to fourth linear valves after cutting off the current, the current value to one or more of the first to fourth linear valves is adjusted based on the W/C pressures detected by one or more of the pressure sensors. Thus, it is possible to find the current value corresponding to the differential pressures generated by the first to fourth linear valves. In this way, it is possible to make the current to be supplied to the linear valves quickly regain the current values matching the differential pressures being generated at the linear valves.

The vehicle brake control device may execute the first and/or second current OFF control by connecting both ends of the one of the first to fourth liner valves with the ground.

### BRIEF DESCRIPTION OF THE DRAWINGS

The invention, together with additional objective, features and advantages thereof, will be best understood from the following description, the appended claims and the accompanying drawings. In the drawings:

FIG. 1 is a diagram showing a hydraulic circuit configuration of a vehicle brake control device according to the first embodiment of the present invention;

FIG. 2 is a block diagram showing input-output relationships of signals of a brake ECU that controls a control system of the vehicle brake control device shown in FIG. 1;

FIG. 3 is a schematic diagram showing operating states of portions in the vehicle brake control device in normal braking and in an abnormal situation;

FIG. 4 is a flowchart showing a brake control process;

FIG. 5 is a timing chart showing changes in current values for the linear valves and W/C pressures;

FIG. 6 is a diagram showing a hydraulic circuit configuration of a vehicle brake control device according to the second embodiment of the present invention;

FIG. 7 is a diagram showing a hydraulic circuit configuration of a vehicle brake control device according to the third embodiment of the present invention;

FIG. 8 is a diagram showing a hydraulic circuit configuration of a vehicle brake control device according to another embodiment of the present invention;

FIG. 9 is a diagram showing a hydraulic circuit configuration of a vehicle brake control device according to still another embodiment of the present invention; and

FIG. 10 is a diagram showing an example of an electrical circuit achieving cutting off the currents to the linear valves.

### DETAILED DESCRIPTION OF THE EMBODIMENTS

Embodiments of the present invention will be described below with reference to the drawings. In the embodiments below, identical reference symbols are used in the drawings to represent identical or equivalent elements.

### First Embodiment

A vehicle brake control device according to a first embodiment of the present invention is applied to a vehicle with an X-shaped hydraulic circuit including two conduit systems, one of which serves the right front wheel and the left rear wheel and the other of which serves the left front wheel and the right rear wheel.

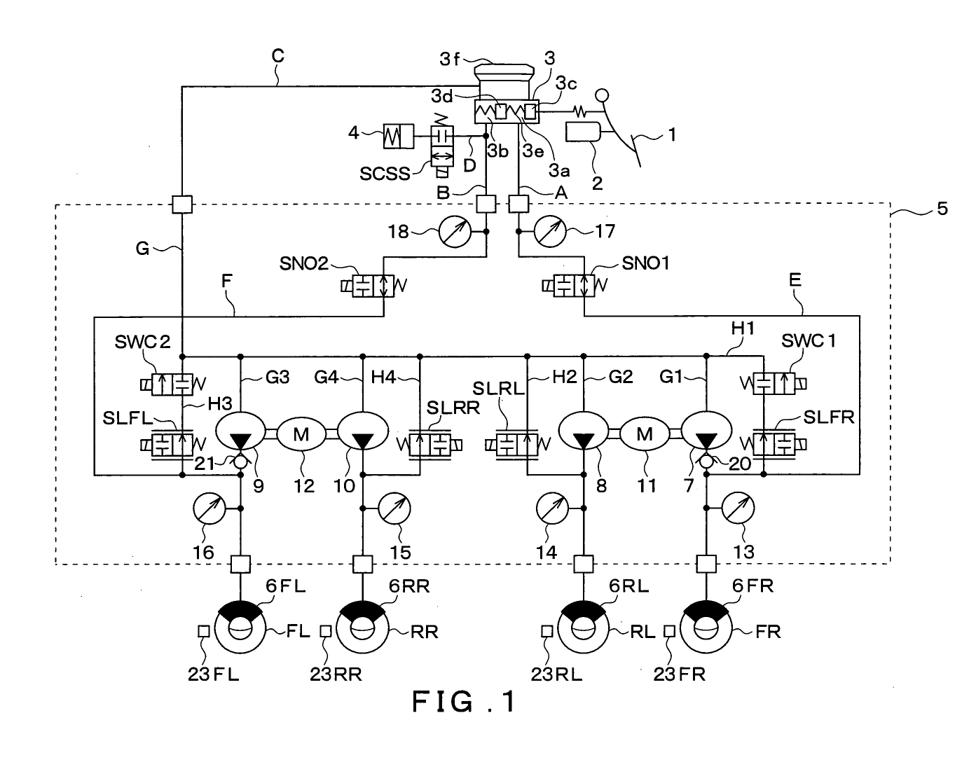

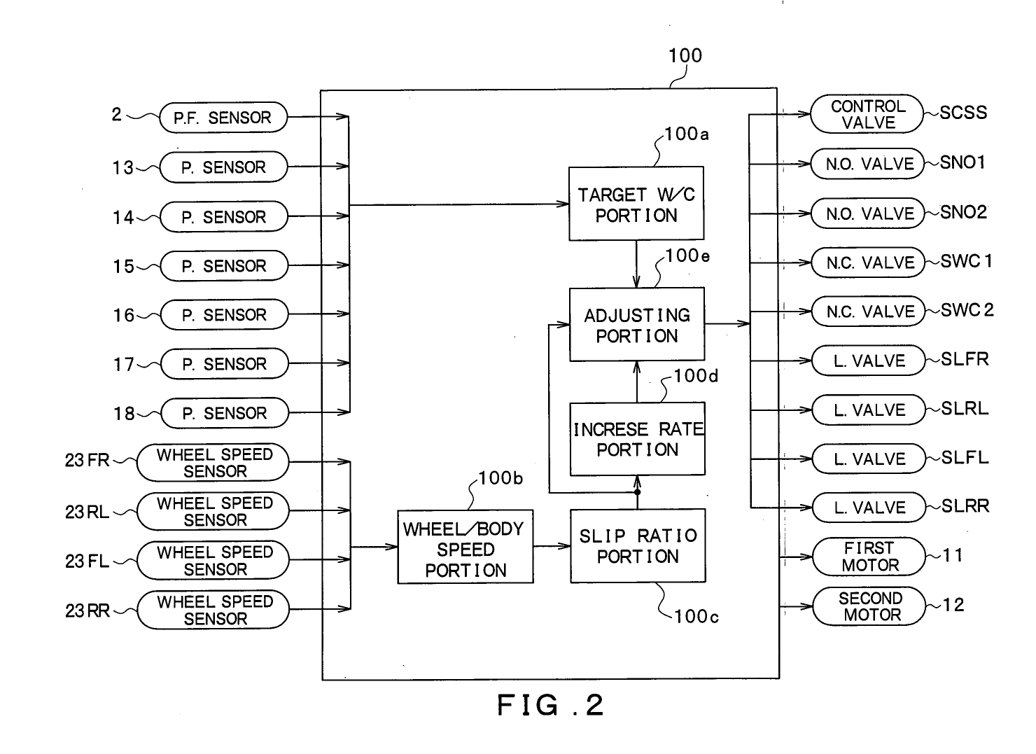

As shown in FIG. 1, the vehicle brake control device includes a brake pedal 1, a depression force sensor 2, a master cylinder (hereinafter referred to as an M/C) 3, a stroke control valve SCSS, a stroke simulator 4, a brake fluid pressure control actuator 5, and wheel cylinders (hereinafter referred to as W/Cs) 6FL, 6FR, 6RL, 6RR, as well as a brake ECU 100 shown in FIG. 2.

When the brake pedal 1, which is an example of a brake operating member, is depressed by a driver, the depression force applied to the brake pedal 1 is inputted to the depression force sensor 2, and a detection signal corresponding to the applied depression force is outputted by the depression force sensor 2. The detection signal is inputted to the brake ECU 100, and thus the depression force applied to the brake pedal 1 is detected by the brake ECU 100. Although the depression force sensor 2 is used as an example of an operation amount sensor for detecting an amount of operation to the brake operating member, a stroke sensor or the like may also be used as another example of the operation amount sensor. The vehicle brake control device may also be configured such that it detects a state of operation of the brake pedal 1 based on detection signals from a stroke sensor and pressure sensors 17 and 18, which detect an M/C pressure described later.

A push rod or the like is connected with the brake pedal 1 and transmits the applied depression force to the M/C 3. When the push rod or the like is pushed, the M/C pressure is generated in a primary chamber 3a and a secondary chamber 3b, which are provided in the M/C 3.

The M/C 3 includes a primary piston 3c and a secondary piston 3d, which form and demarcates the primary chamber 3a and the secondary chamber 3b. The primary piston 3c and the secondary piston 3d receive an elastic force of a spring 3e, thereby return the brake pedal 1 to its initial position when the brake pedal 1 becomes free from the depression force.

The vehicle brake control device also includes brake conduits A and B, which extend respectively from the primary chamber 3a and the secondary chamber 3b of the M/C 3 to the brake fluid pressure control actuator 5.

The M/C 3 also includes a master reservoir 3f. While the brake pedal 1 is in its initial position, the master reservoir 3f is connected with the primary chamber 3a and the secondary chamber 3b via channels not shown in FIG. 1, supplies brake fluid to the M/C 3, and stores any surplus brake fluid.

A brake conduit C directly extends from the master reservoir 3f to the brake fluid pressure control actuator 5.

The stroke simulator 4 is connected with a brake conduit D extending to the brake conduit B and receives the brake fluid in the secondary chamber 3b. The stroke control valve SCSS, a type of normally-closed two-position valve, is provided in the brake conduit D and controls open and closed states of the brake conduit D. A normally closed two-position valve opens a path to which it is installed while electrical power is supplied to it, and closes the path while electrical power is not supplied to it. The configuration allows the stroke control valve SCSS to control the flow of brake fluid to the stroke simulator 4.

The brake fluid pressure control actuator 5 is configured as described below.

The actuator 5 includes a brake conduit E which is connected with the brake conduit A so that the primary chamber 3a is connected via the brake conduit E with the W/C (first front wheel W/C) 6FR, which corresponds to a front wheel FR. A first normally-open valve (a first control valve) SNO1 is located in the brake conduit E. The first normally-open valve SNO1 is a two-position valve that opens a path to which it is installed while electrical power is not supplied to it, and closes the path while electrical power is supplied to it. The first normally-open valve SNO1 controls the open and closed states of the brake conduit E.

The actuator 5 also includes a brake conduit F which is connected with the brake conduit B so that the secondary chamber 3b is connected via the brake conduit F with the W/C (second front wheel W/C) 6FL, which corresponds to a front wheel FL. A second normally-open valve (a second control valve) SNO2 is located in the brake conduit F. The second normally-open valve SNO2 is a two-position valve that opens a path to which it is installed while electrical power is not supplied to it, and closes the path while electrical power is supplied to it. The second normally-open valve SNO2 thus controls the open and closed states of the brake conduit F.

The actuator also includes a brake conduit G which is connected with the brake conduit C that extends from the master reservoir 3f. The brake conduit G branches into four brake conduits called brake conduits G1, G2, G3, and G4 which are respectively connected with the W/Cs 6FR, 6RL, 6FL, and 6RR, wherein the W/Cs 6FL and 6FR respectively correspond to the front wheels FL and FR, and the W/Cs (first and second rear wheel W/Cs) 6RL and 6RR respectively correspond to the rear wheels RL and RR. Note that the brake conduit G includes the brake conduits G1 to G4.

The brake conduits G1 to G4 are respectively provided with pumps (first to fourth pumps) 7, 8, 9, 10. The pumps 7 to 10 are configured as, for example, trochoid pumps which are effective for quietness. The pumps 7 and 8 are driven by a first motor 11, and the pumps 9 and 10 are driven by a second motor 12. Each of the first motor 11 and the second motor 12 may be of any kind of motor, but a brushless motor is preferable because it increases its rotational speed quickly after it starts rotating.

Brake conduits H1, H2, H3, and H4 are located in parallel with the pumps 7 to 10, respectively.

A first normally-closed valve SWC1 and a first linear valve SLFR are located in series in the brake conduit H1 connected in parallel with the pump 7. The first normally-closed valve SWC1 is located closer than the linear valve SLFR is to the intake side (upstream side) of the pump 7, and the first linear valve SLFR is located closer than the first normally-closed valve SWC1 is to the discharge side (downstream side) of the pump 7. In other words, a return flow returning through the brake conduit H1 to the master reservoir 3f can be controlled by using the first normally-closed valve SWC1.

A second linear valve SLRL is located in the brake conduit H2 connected in parallel with the pump 8.

A second normally-closed valve SWC2 and a third linear valve SLFL are located in series in the brake conduit H3 connected in parallel with the pump 9. The second normally-closed valve SWC2 is located closer than the third linear valve SLFL is to the intake side (upstream side) of the pump 9, and the third linear valve SLFL is located closer than the second normally-closed valve SWC2 is to the discharge side (downstream side) of the pump 9. In other words, a return flow returning through the brake conduit H3 to the master reservoir 3f can be controlled by using the second normally-closed valve SWC2.

A fourth linear valve SLRR is located in the brake conduit H4 connected in parallel with the pump 10;

A first pressure sensor 13, a second pressure sensor 14, a third pressure sensor 16, and a fourth pressure sensor 15 are respectively located in the brake conduits G1 to G4, between the pumps 7 to 10 and the W/Cs 6FR to 6RR, and are configured in such a way that the pressures in each of the W/Cs can be detected. The pressure sensors 17 and 18 are respectively located in the brake conduits E and F on the upstream sides (the M/C 3 sides) of the first and second normally-open valves SNO1, SNO2, and are configured in such a way that an M/C pressure that is generated in the primary chamber 3a and the secondary chamber 3b of the M/C 3 can be detected. The detection signals from the pressure sensors 13 to 18 are inputted to the brake ECU 100, as shown in FIG. 2.

Check valves 20 and 21 are respectively located in the discharge port of the pump 7 which pressurizes the W/C 6FR, and in the discharge port of the pump 9 which pressurizes the W/C 6FL. The check valves 20 and 21 are provided to prevent brake fluid from flowing respectively from the W/Cs 6FR and 6FL to the pumps 7 and 9.

In the vehicle brake control device, a first conduit system includes a hydraulic circuit (a first auxiliary brake conduit) that connects the primary chamber 3a with the W/C 6FR via the brake conduit A and the brake conduit E. The first conduit system also includes a hydraulic circuit (a first main brake conduit) that connects the master reservoir 3f and the W/Cs 6FR and 6RL via the brake conduits C G, G1, and G2. The first conduit system further includes hydraulic circuits (first and second pressure-adjusting brake conduits) having the brake conduits H1 and H2, which are connected in parallel with the pumps 7 and 8, respectively.

Also in the vehicle brake control device, a second conduit system includes a hydraulic circuit (a second auxiliary brake conduit) that connects the secondary chamber 3b and the W/C 6FL via the brake conduit B and the brake conduit F. The second conduit system also includes a hydraulic circuit (a second main brake conduit) that connects the master reservoir 3f and the W/Cs 6FL and 6RR via the brake conduits C, G, G3, and G4. The second conduit system further includes hydraulic circuits (third and fourth pressure-adjusting brake conduits) having the brake conduits H3 and H4, which are connected in parallel with the pumps 9 and 10, respectively.

The vehicle brake control system also includes wheel speed sensors 23FR, 23RL, 23FL, and 23RR respectively for detecting wheel speeds of the wheels FR, RL, FL, and RR. A wheel speed of a wheel is the product of a rotational speed of the wheel and a circumference of the wheel. Detection signals from the wheel speed sensors 23FR to 23RR are inputted into the brake ECU 100.

The brake ECU 100 includes a well-known microcomputer which has a CPU, a ROM, a RAM, and an I/O. The brake ECU 100 executes, according to programs stored in the ROM and the like, several kinds of brake control processes. The brake ECU 100 includes semiconductor switching elements (not shown) for controlling ON/OFF states of power supply lines for the control valves SCSS, SNO1, SNO2, SWC1, SWC2, SLFR, SLRL, SLFL, SLRR, the first motor 11, and the second motor 12. ON/OFF of the power supply to the valves and the motors and an average of current values of electrical currents to be supplied to the valves and the motors can be controlled by, for example, using the ON/OFF control of the semiconductor switching elements.

More specifically, the brake ECU 100 includes a target W/C pressure calculating portion (hereinafter referred to as a target W/C portion) 100a, a wheel/body speed calculating portion (hereinafter referred to as a wheel/body speed portion) 100b, a slip ratio calculating portion (hereinafter referred to as a slip ratio portion) 100c, a slip ratio increase rate calculating portion (hereinafter referred to as an increase rate portion) 100d, and a linear valve output adjusting portion (hereinafter referred to as an adjusting portion) 100e, and the like.

The target W/C pressure calculating portion 100a calculates target W/C pressures which are pressures required to generate a target brake force. More specifically, the portion 100a calculates, based on the detection signal from the depression force sensor 2, a physical quantity of a depression force corresponding to the amount of the operation to the brake pedal 1. The amount of the operation to the brake pedal 1 will be referred to as a pedaling amount. Then the portion 100a calculates the target W/C pressures corresponding to the physical quantity. The target W/C pressures are proportional to the pedaling amount and is determined based on a mapping dataset or a formula which indicates a relation between the pedaling amount and values for a target W/C pressure. The mapping dataset may be stored in a storage device.

The wheel/body speed portion 100b calculates the wheel speeds of the wheels FR to RR based on the detection signals from the wheel speed sensors 23FR to 23RR. The portion 100b then calculates a speed of the body of the vehicle based on the calculated wheel speeds. The speed of the body of the vehicle will be referred to as a body speed. Methods for calculating the body speed is not described in detail because it is known well.

The slip ratio calculating portion 100c repeatedly calculates slip ratios of the wheels FR to RR. A slip ratio of a wheel is calculated as a deviation of the calculated wheel speed of the wheel from the calculated body speed. More specifically, each of the slip ratios is calculated as a speed difference divided by the body speed, where the speed difference is a difference of a corresponding wheel speed from the body speed.

The increase rate portion 100d calculates increase rates of the slip ratios calculated by the slip ratio portion 100c. More specifically, the increase rate portion 100d calculates each of the increase rates by calculating a difference Δρ=ρ(N)−ρ(N−1) between a present slip ratio ρ(N) for a corresponding wheel calculated at the Nth calculation timing and a previous slip ratio ρ(N−1) calculated for the corresponding wheel at the (N−1)th calculation timing and further by determining the increase rate to be a value Δρ/ΔT which is the difference Δρ divided by a calculation timing interval ΔT=T(N)−T(N−1).

The adjusting portion 100e calculates, based on the target W/C pressures, on pressures detected by the pressure sensors 13 to 16, and on the result of the calculations of the slip ratio portion 100c and increase rate portion 100d, current values for electrical currents to be supplied to the linear valves SLFR to SLRR. The adjusting portion 100e then adjusts the electrical currents to be supplied to the linear valves SLFR to SLRR based on the calculated current values. For example, the adjusting portion 100e determines an average of each of the current values in an interval by determining duty factors related to ON/OFF of the currents to the SLFR to SLRR. The adjusting portion 100e controls the averages of the current values by controlling ON/OFF of the semiconductor switching elements located in power supply lines to the first to fourth linear valves SLFR to SLRR, so that differential pressures generated at the first to fourth linear valves SLFR to SLRR have values suitable for the calculated target W/C pressures. Each of the differential pressures is a difference in the brake fluid pressure between both ends of its corresponding valve.

The brake ECU 100 also generates the W/C pressures at the W/Cs 6FR to 6RR by outputting control signals (more specifically, control currents) for driving the control valves SCSS, SNO1, SNO2, SWC1, SWC2, the first motor 11, and the second motor 12 by means of the adjusting portion 100e. The brake ECU 100 also detects the generated W/C pressures and the M/C pressure based on the detection signals from the sensors 13 to 18 and accordingly loops back an actual brake force generated at the wheels to a control for achieving a target brake force.

The signals for driving the brake ECU 100, the control valves SCSS, SNO1, SNO2, SWC1, SLFR, SLRL, SLFL, SLRR, the first motor 11, and the second motor 12 are supported by power supply from a on-board battery (not shown).

The operation of the brake control device during normal braking and in an abnormal situation will be described below separately.

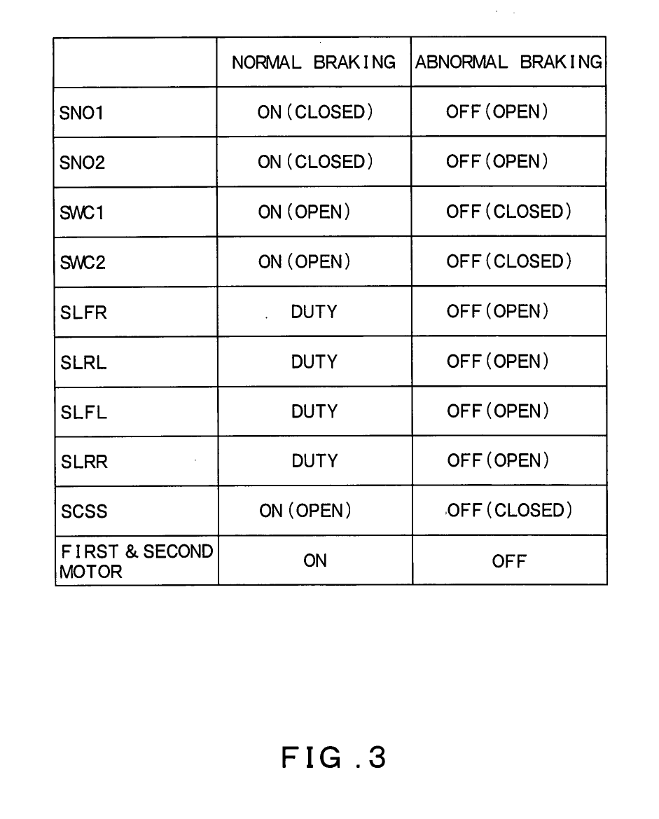

FIG. 3 is a table showing the operating states of portions of the vehicle brake control device during the normal braking and in the abnormal situation. The brake ECU 100 determines, by executing a conventional initial check or the like, whether or not the abnormal situation has arose. If the abnormal situation arises, abnormal-state braking operation is executed until the abnormal situation goes away. Hereinafter, the operation during the normal braking and in the abnormal situation will be described with reference to FIG. 3.

(1) Operation During the Normal Braking:

The normal braking refers to the situation at which no abnormal situation related to the brake operation is occurring. Therefore, the situation corresponding to the normal braking includes an emergency situation in which the ABS control is in operation.

During the normal braking, when the brake pedal 1 is depressed and the detection signal from the depression force sensor 2 is inputted to the brake ECU 100, the brake ECU 100 operates the various control valves SCSS, SNO1, SNO2, SWC1, SWC2, SLFR, SLRL, SLFL, SLRR, and the first and second motors 11, 12 such that they are basically in the operating states shown in FIG. 3.

More specifically, the brake ECU 100 controls the target W/C portion so that it calculates the target W/C pressures based on the detection signal from the depression force sensor 2. Then the brake ECU 100 controls the adjusting portion 100e so that it calculates differential pressures to be generated at the first to fourth linear valves SLFR to SLRR and generates the differential pressures at the first to fourth linear valves SLFR to SLRR by controlling the current values of the currents supplied to the first to fourth linear valves SLFR to SLRR. The current values are determined by a brake control process.

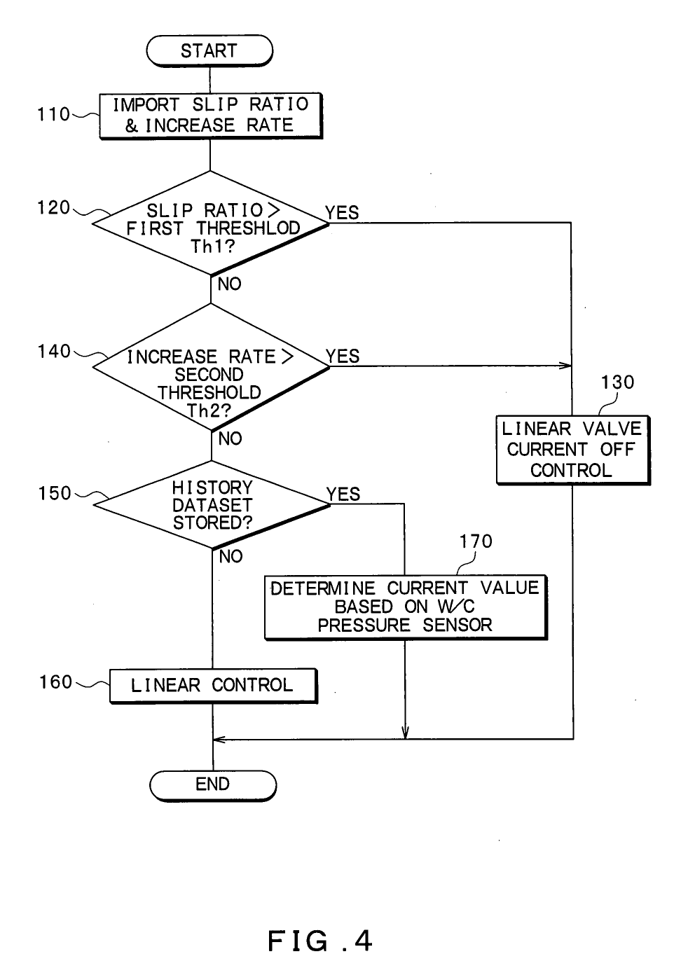

The brake control process will be described with reference to a flowchart shown in FIG. 4. The brake control process shown in FIG. 4 is executed for each of the wheels repeatedly in a predetermined calculation interval until the brake ECU 100 detects an occurrence of an abnormal situation. The predetermined calculation interval is determined by the adjusting portion 100e before executing the brake control process.

As shown in FIG. 4, the brake ECU 100 imports a slip ratio and an increase rate of the slip ratio for a corresponding wheel (hereafter referred to as a subject wheel). The slip ratio and the increase rate to be imported are calculated respectively by the slip ratio portion 100c and the increase rate portion 100d based on the wheel speed for the subject wheel and the body speed calculated by the wheel/body speed portion 100b.

Subsequently at step 120, the brake ECU 100 makes a determination as to whether the imported slip ratio is larger than a first threshold Th1. The first threshold Th1 is a reference value to be used to determine whether the depressurizing should be started in the ABS control. The slip ratio exceeding the first threshold Th1 implies that the ABS control is started and that the pressure at the subject wheel starts decreasing. In most cases, the determination at step 120 becomes negative and the process accordingly proceeds to step 140.

At step 140, the brake ECU 100 makes a determination as to whether the imported increase rate is larger than a second threshold T2. The second threshold T2 is an increase rate of a slip ratio which cannot be compensated for by a conventional control of current values to the first to fourth linear valves SLFR, SLRL, SLFL, and SLRR. Therefore, the second threshold T2 varies depending on characteristics of the first to fourth linear valves SLFR, SLRL, SLFL, and SLRR. In most cases, the determination at step 140 becomes negative and the process accordingly proceeds to step 150.

Thus, the increase rate portion 100d detects at step 120 a situation in which the imported slip ratio is larger than the first threshold Th1 and detects at step 140 a situation in which the imported increase rate is larger than the second threshold Th2. The increase rate portion 100d executes step 130 when one of the situations is detected. The brake. ECU 100 serves as an example of a current cutting means when the brake ECU 100 executes step 130.

At step 130, the brake ECU 100 executes a linear valve current OFF control (a first current OFF control and second current OFF control). In the linear valve current OFF control, the brake ECU 100 cuts off the currents to one of the first to fourth linear valves SLFR, SLRL, SLFL, and SLRR corresponding to the wheel irrespective of the calculated target W/C pressure for the subject wheel. The brake ECU 100 can keep the current cut off for, for example, a predetermined constant period. Alternatively, the brake ECU 100 may calculate beforehand a period necessary for depressurizing the W/C corresponding to the wheel and keep the current cut off for the calculated period.

When a control signal for each of the first to fourth linear valves SLFR, SLRL, SLFL, and SLRR indicates 0 MPa, a weak current such as a 0.1 A current is supplied to the linear valve. Thus, the control signal indicating 0 MPa does not cut off the current to the first to fourth linear valves SLFR, SLRL, SLFL, and SLRR but lets the weak current be supplied to the linear valves. In contrast, the currents to the first to fourth linear valves SLFR, SLRL, SLFL, and SLRR are cut off in the present embodiment in order to completely prohibit supply of the current to the first to fourth linear valves SLFR, SLRL, SLFL, and SLRR.

Thus, it is possible to avoid slow depressurization of the W/C pressures caused by the weak currents. In other words, it is possible to achieve quick response in the W/C pressures which allows the depressurization to work well.

After the linear valve current OFF control, the brake ECU 100 stores a history dataset indicating that the linear valve current OFF control is executed for the Wheel. The history dataset may be a flag (not shown) which is turned to ON to indicate that the linear valve current OFF control is executed for the subject wheel. After storing the history dataset, the brake ECU 100 terminates the brake control, process. In this case, the brake control process for the next execution timing starts from step 110.

If the determination at step 140 is negative, the 100 subsequently makes at step 150 a determination as to whether the history dataset is stored. More specifically, the brake ECU 100 determines whether the flag is in the ON state. If the flag is not in the ON state, the process proceeds to step 160. If the flag is in the ON state, the process proceeds to step 170.

At step 160, the brake ECU 100 executes an ordinary linear control. The ordinary linear control refers to a control in which the current values of the currents to the first to fourth linear valves SLFR, SLRL, SLFL, and SLRR are determined based on the W/C pressures calculated by the target W/C portion 100a. Therefore, the first to fourth linear valves SLFR, SLRL, SLFL, and SLRR generate the differential pressures in accordance with the target W/C pressure in the ordinary linear control.

At step 170, the brake ECU 100 imports the W/C pressure detected by one of the pressure sensors 13 to 16 corresponding to the subject wheel, for which the present linear valve current OFF control is executed. The brake ECU 100 further determines at step 170 the current value to the linear valve corresponding to the wheel based on the detected W/C pressure.

The differential pressures generated at the first to fourth linear valves SLFR, SLRL, SLFL, and SLRR can be detected based on the current values of the currents to the linear valves, because the differential pressures are controlled by adjusting the current values to the linear valves. Therefore, the differential pressures can always be detected while the current values to the linear valves are controlled as in the ordinary linear control. However, the differential pressures at the first to fourth linear valves SLFR, SLRL, SLFL, and SLRR cannot be detected based on the current values while in the linear valve current OFF control.

Therefore, when the determination at step 150 is affirmative, the brake ECU 100 calculates at step 170 the current values to be supplied to the one of the first to fourth linear valves SLFR, SLRL, SLFL, and SLRR based on the detected W/C pressure. Therefore, it is possible to determine the current value which matches the differential pressure at the one of the linear valves. In this way, it is possible to make the current to be supplied to the linear valve regain quickly the current value matching the differential pressure being generated at the linear valve. The flag described above is turned to OFF when the determination at step 150 becomes affirmative. The flag described above is also turned to OFF in the case that the determination at step 150 when the travel speed of the vehicle becomes zero.

Thus, the current values of the currents to be supplied to the first to fourth linear valves SLFR, SLRL, SLFL, and SLRR are determined. In keeping and increasing W/C pressures in the ABS control, the brake ECU 100 calculates the current values to the first to fourth linear valves SLFR, SLRL, SLFL, and SLRR based on the target differential pressures (which are identical with the target W/C pressures) determined for the wheels, as well as on the ordinary linear control.

Electric power to both the first and second normally-open valves SNO1 and SNO2 is turned to ON, and electric power to both the first and second normally-closed valves SWC1 and SWC2 is turned to ON. Therefore, the first and second normally-open valves SNO1 and SNO2 are both put into a closed state, and the first and second normally-closed valves SWC1 and SWC2 are both put into an open state.

Electric power to the stroke control valve SCSS is turned to ON, causing the stroke simulator 4 to be connected with the secondary chamber 3b through the brake conduits B and D. In this case, the brake fluid in the secondary chamber 3b moves to the stroke simulator 4 when the brake pedal is depressed and the pistons 3c and 3d move. Therefore, when the driver depresses the pedal 1, a reaction force corresponding to an amount of the depression is generated. The brake pedal 1 can hence be depressed without making the driver feel that depressing the brake pedal 1 becomes like pressing a hard board (i.e. giving a board feeling) as a result of the increase in the master cylinder pressure.

In addition, electric power is supplied to the first and second motors 11 and 12 and the pumps 7 to 10 accordingly draws in and discharges the brake fluid. In this manner, the brake fluid is supplied to the W/Cs 6FR to 6RR when the pumps 7 to 10 perform pumping operation.

Since the first and second normally-open valves SNO1 and SNO2 are in a closed state at this time, the brake fluid discharged by the pumps 7 to 10 increases the brake fluid pressures downstream of the pumps 7 to 10, that is, the W/C pressures of the W/Cs 6FR to 6RR.

Since the first and second normally-closed valves SWC1 and SWC2 are in an open state and the average amount of electric energy supplied per unit time to the first to fourth linear valves SLFR, SLRL, SLFL, and SLRR are subject to duty control, the W/C pressures of the W/Cs 6FR to 6RR are adjusted according to duty factors of the current value for the linear valves SLFR, SLRL, SLFL, and SLRR.

The brake ECU 100 monitors the W/C pressures in the W/Cs 6FR to 6RR based on the detection signals from the pressure sensors 13 to 16. The brake ECU 100 accordingly adjusts the W/C pressures to desired values by adjusting the amounts of electric power supplied to the first and second motors 11 and 12 to control the revolution speeds thereof and by controlling the ON/OFF duty ratios for the electric power that is supplied to the first to fourth linear valves SLFR, SLRL, SLFL, and SLRR.

Thus, the braking force generated so that the generated braking force becomes a target braking force which depends on the depression force on the brake pedal 1. In the case that the slip ratio is larger than the first threshold Th1 and in the case that the increase rate of the slip ratio is larger than the second threshold Th2, the depressurization in the ABS control is made fast. It is therefore possible to avoid, in the improved manner, locking the wheels FR to RR from.

(2) Abnormal-State Braking Operation

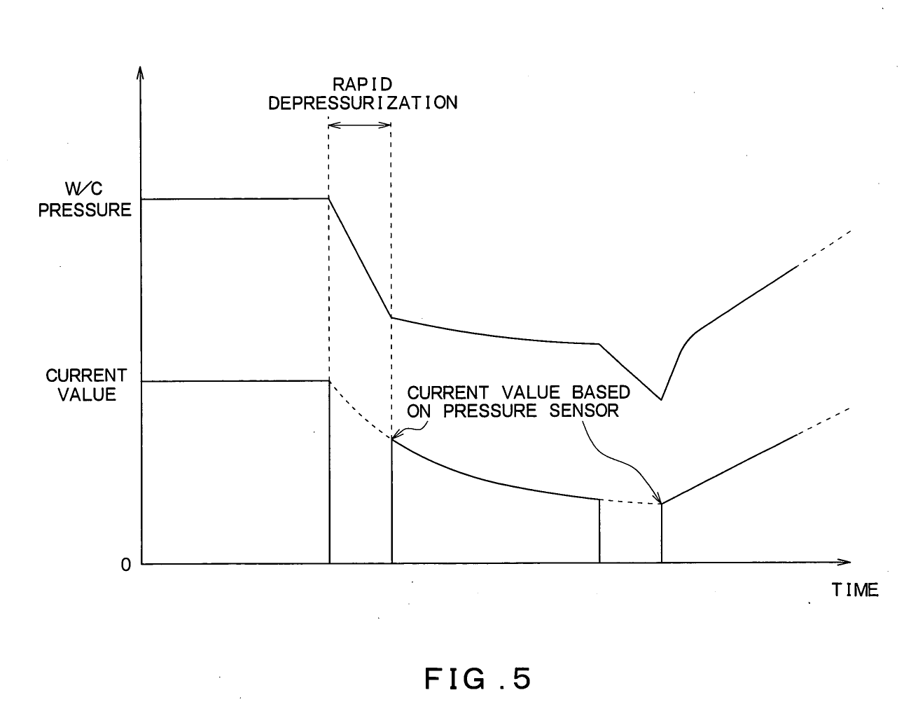

When an abnormal situation arises in the vehicle brake control device, there is a possibility that control signals cannot be outputted from the brake ECU 100, or that some of the control valves SCSS, SNO1, SNO2, SWC1, SWC2, SLFR, SLRL, SLFL, SLRR or the first and second motors 11, 12 do not work properly. In this case, electric power to the various control valves SCSS, SNO1, SNO2, SWC1, SWC2, SLFR, SLRL, SLFL, SLRR and the first and second motors 11, 12 is turned to OFF as shown in FIG. 5.

Since the electric power to both the first and second normally-open valves SNO1 and SNO2 is turned to OFF, both valves SNO1 and SNO2 are in the open states. Since the electric power to both the first and second normally-closed valves SWC1 and SWC2 is turned to OFF, both valves SWC1 and SWC2 are in the closed states.

Since the electric power to all of the first to fourth linear valves SLFR, SLRL, SLFL, and SLRR is turned to OFF, they are in the open states. Since electric power to the stroke control valve SCSS is also turned to OFF, the stroke simulator 4 and the secondary chamber 3b are cut off from each other.

Since the electric power to the first and second motors 11 and 12 is turned to OFF, the pumps 7 to 10 stop drawing in and discharging the brake fluid.

At this time, the primary chamber 3a of the M/C 3 is in a state in which it is connected with the W/C 6FR in the right front wheel FR via the brake conduits A, E, and G1, and the secondary chamber 3b is in a state in which it is connected with the W/C 6FL in the left front wheel FL via the brake conduits B, F, and G3.

Therefore, if the brake pedal 1 is depressed and the push rod or the like is pushed according to the applied depression force, the M/C pressure is generated in the primary chamber 3a and the secondary chamber 3b and the M/C pressure is transmitted to the W/Cs 6FR and 6FL. Braking force is thereby generated for both front wheels FR and FL.

In the abnormal-state braking operation described above, the W/C pressures in the W/Cs 6FR and 6FL on the front wheels also takes effect in the brake conduits G1 and G3. However, the check valves 20 and 21 prevent the W/C pressures from bearing on the pumps 7 and 9 and thereby prevent the brake fluid leaking through the pumps 7 and 9. The W/C pressures therefore are not decreased because of leaking of the brake fluid.

As described above, the vehicle brake control device of the present embodiment cuts off one or more of the first to fourth linear valves SLFR, SLRL, SLFL, and SLRR in order to prohibit completely supply of the current to the first to fourth linear valves SLFR, SLRL, SLFL, and SLRR, in the case that the slip ratio is larger than the first threshold Th1 and in the case that the increase rate of the slip ratio is larger than the second threshold Th2. Thus, it is possible to avoid slow depressurization of the W/C pressures caused by the weak currents. In other words, it is possible to achieve quick response in the W/C pressures which allows the depressurization to work well.

FIG. 5 is a timing chart showing the changes of the current values for the first to fourth linear valves SLFR, SLRL, SLFL, and SLRR and the W/C pressures. As shown in the drawing, the current values for the linear valves are controlled based on the target W/C pressures when a slow depressurization of the W/Cs is sufficient for the proper operation of the vehicle brake control device. In contrast, the current values for the linear valves are cut off when a rapid depressurization of the W/Cs is required. It can be seen in the drawing that it is possible to achieve quick response in the W/C pressures which allows the depressurization to work well.

In addition, in supplying again the currents to one or more of the first to fourth linear valves SLFR, SLRL, SLFL, and SLRR after cutting off the currents, the current value to one or more of the first to fourth linear valves SLFR, SLRL, SLFL, and SLRR are determined based on the W/C pressures detected by one or more of the pressure sensors 13 to 16. Thus, it is possible to find the current values matching the differential pressures generated by the first to fourth linear valves SLFR, SLRL, SLFL, and SLRR. In this way, it is possible to make the currents to be supplied to the linear valves quickly regain the current values matching the differential pressures being generated at the linear valves.

### Second Embodiment

A second embodiment of the present invention will be described. In this embodiment, a portion of the configuration of the vehicle brake control device is different from the configuration in the first embodiment, but the overall configuration is basically the same as that in the first embodiment, so only the parts which are different from the first embodiment will be described.

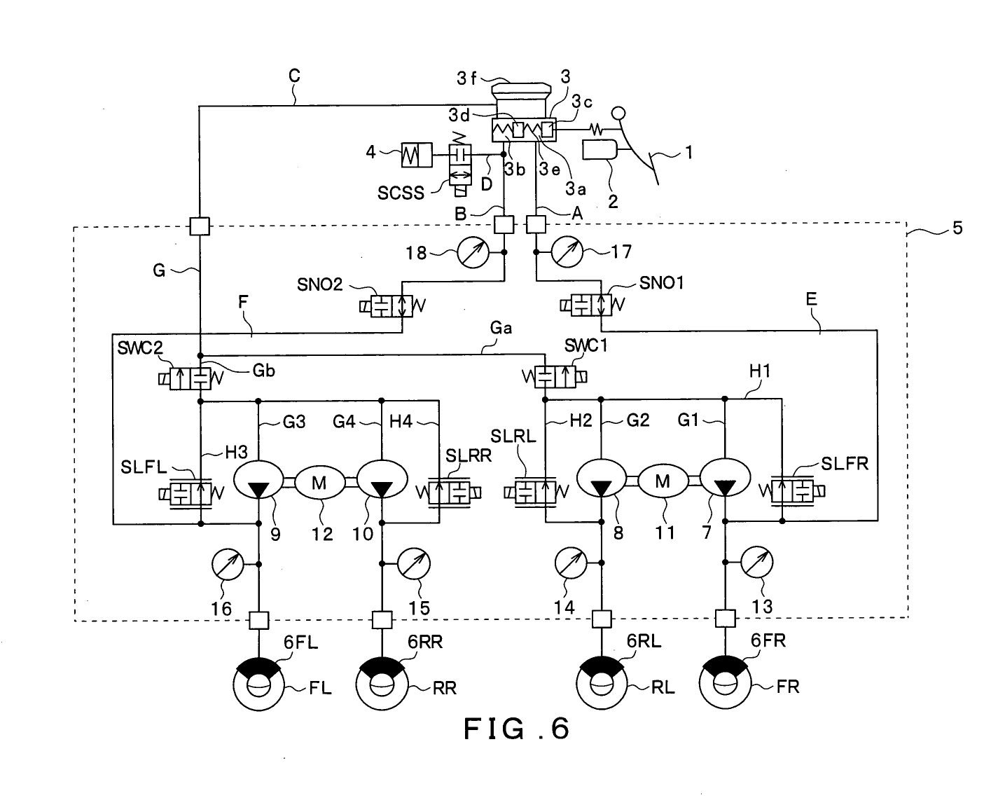

FIG. 6 is a diagram showing a hydraulic circuit configuration of a vehicle brake control device according to this embodiment. As shown in FIG. 6, in the vehicle brake control device in this embodiment, the brake conduit G is divided into two brake conduits Ga and Gb. The first normally-closed valve SWC1 is located in the brake conduit Ga (that is, downstream of the dividing point of the conduits Ga and Gb and upstream of the brake conduits H1 and H2). The second normally-closed valve SWC2 is located in the brake conduit Gb (that is, downstream of the dividing point and upstream of the brake conduits H3 and H4).

The vehicle control device with the structure described above achieves the same effect as that of the first embodiment if it cuts off one or more of the first to fourth linear valves SLFR, SLRL, SLFL, and SLRR in order to completely prohibit supply of the current to the first to fourth linear valves SLFR, SLRL, SLFL, and SLRR, in the case that the slip ratio is larger than the first threshold Th1 and in the case that the increase rate of the slip ratio is larger than the second threshold Th2.

In this configuration, even if the first normally-closed valve SWC1 is closed when an abnormality occurs, only the portion of the system on the upstream side of the brake conduits H1 and H2 is closed. Therefore, if the M/C pressure is generated in the primary chamber 3a of the M/C 3 because of depressing of a brake pedal 1, the M/C pressure can be transmitted not only to the W/C 6FR for the right front wheel FR, but also to the W/C 6RL for the left rear wheel RL. Likewise, even if the second normally-closed valve SWC2 is closed when an abnormality occurs, only the portion of the system on the upstream side of the brake conduits H3 and H4 is closed. Therefore, if the M/C pressure is generated in the secondary chamber 3b of the M/C 3 because of depressing of the brake pedal 1, the M/C pressure can be transmitted not only to the W/C 6FL for the left front wheel FL, but also to the W/C 6RR for the right rear wheel RR.

Thus, in the vehicle brake control device in this embodiment, it is possible to generate the W/C pressures in the W/Cs 6FR to 6RR for all four wheels FR to RR in the abnormal situation. Better balanced braking forces can therefore be generated.

In this embodiment, check valves 20 and 21, which were shown in the first embodiment, are not provided. However, the first and second normally-closed valves SWC1 and SWC2, which are located upstream of the pumps 7 and 9, can stop the brake fluid so that no drop occurs in the W/C pressures even if the brake fluid leaks from pumps 7 and 9.

### Third Embodiments

Third embodiment of the present invention will be described. In this embodiment, a portion of the configuration of the vehicle brake control device is different from the configuration in the second embodiment, but the overall configuration is basically the same as that in the second embodiment, so only the parts which are different from the second embodiment will be described.

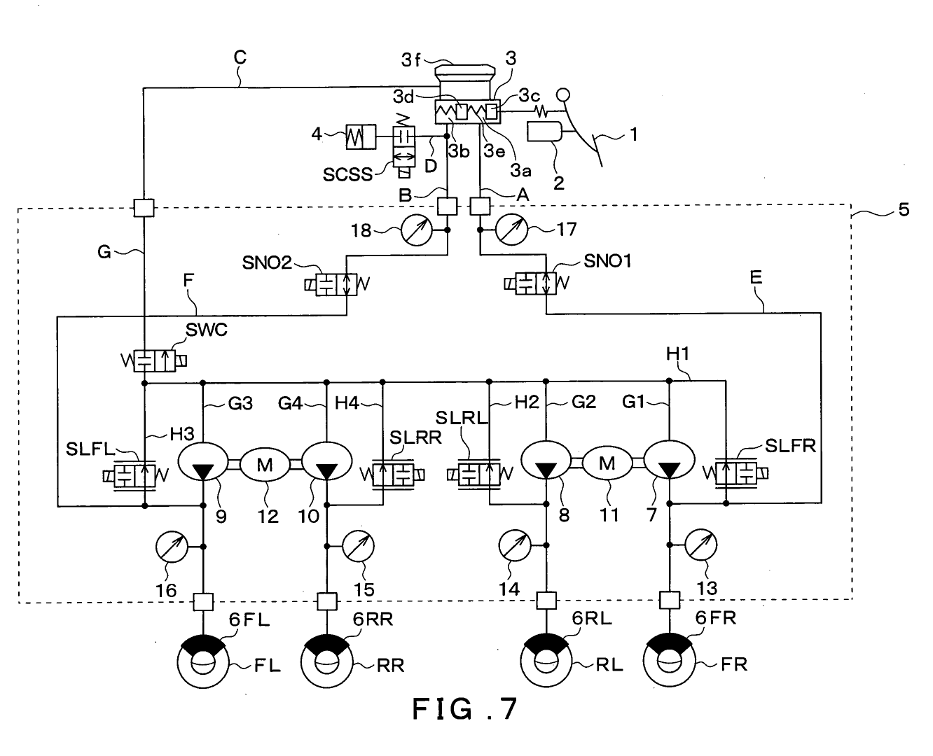

FIG. 7 is a diagram showing a hydraulic circuit configuration of a vehicle brake control device according to this embodiment. As shown in FIG. 7, in the vehicle brake control device in this embodiment, the two conduit systems share a single normally-closed valve SWC, instead of the first and second normally-closed valves SWC1 and SWC2 provided in the first and second embodiments.

The vehicle control device with the structure described above achieves the same effect as that of the first and second embodiments if it cuts off one or more of the first to fourth linear valves SLFR, SLRL, SLFL, and SLRR in order to completely prohibit supply of the current to the first to fourth linear valves SLFR, SLRL, SLFL, and SLRR, in the case that the slip ratio is larger than the first threshold Th1 and in the case that the increase rate of the slip ratio is larger than the second threshold Th2.

Even in this configuration, during the normal braking, W/C pressures in the W/Cs 6FR to 6RR for the four wheels FR to RR can be adjusted appropriately, and when an abnormality occurs, the M/C pressure that is generated in the M/C 3 according to depressing of a brake pedal 1 can be transmitted to the W/Cs 6FR to 6RR for the four wheels FR to RR.

In addition, the single normally-closed valve SWC is closed in the abnormal situation. The M/C pressure is accordingly transmitted to all wheels FR to RR in the two conduit systems. Therefore, it is possible to make the system configuration more compact.

In the vehicle brake control device in this embodiment, the way for driving the normally-closed valve SWC is the same as that for driving the first and second normally-closed valves SWC1 and SWC2 in the vehicle brake control device according to the first embodiment, as shown in FIG. 3.

### Other Embodiment

The way to cut off the currents to one or more of the first to fourth linear valves SLFR, SLRL, SLFL, and SLRR is not limited to that described above. For example, in a software fashion, the brake ECU 100 may output control signals indicating 0 A of the current value to the one or more of the first to fourth linear valves SLFR, SLRL, SLFL, and SLRR. In a hardware fashion, the vehicle brake control device may include an electrical circuit which achieves 0 A of the currents to the one or more of the first to fourth linear valves SLFR, SLRL, SLFL, and SLRR. For example, the vehicle brake control device may include an additional electrical circuit which connects both ends of coils for driving the linear valves with the ground.

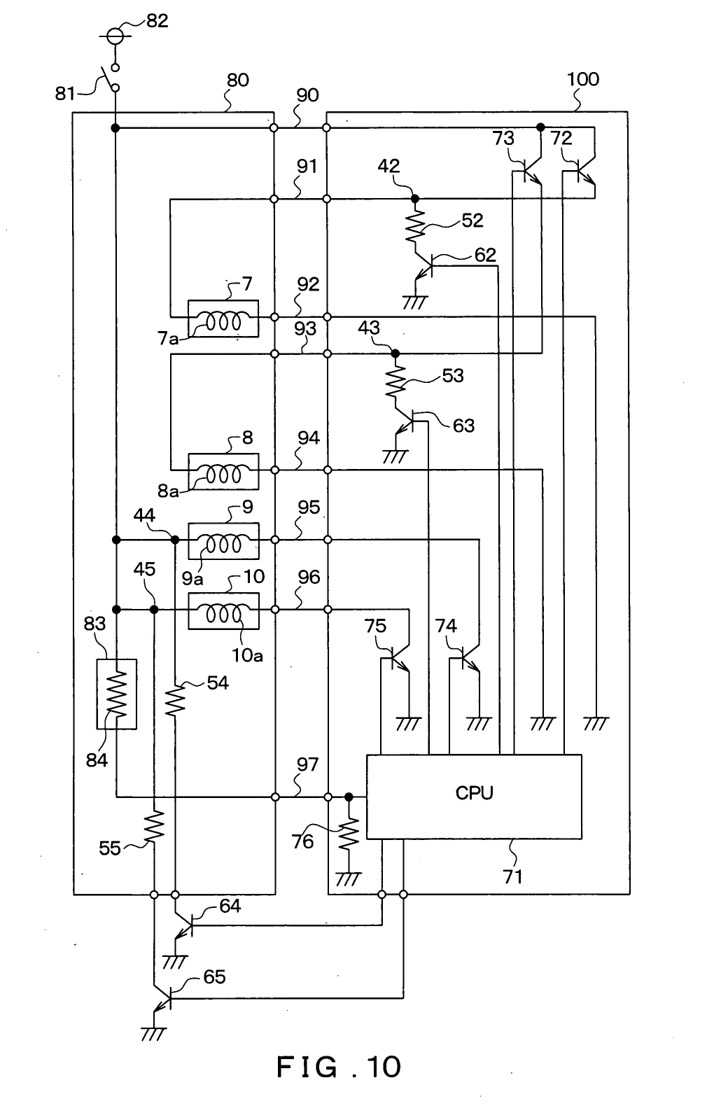

As an example of the additional electrical circuit, FIG. 10 shows a board 80 on which the first to fourth linear valves 7, 8, 9, and 10 are mounted, the electrical connections to the brake ECU 100, and a drive circuit provided in the brake ECU 100. The drive circuit is for the first to fourth linear valves 7 to 10.

As shown in the drawing, the first to fourth linear valves 7 to 10 are connected with the board 80 in order. Solenoid coils 7a, 8a, 9a, and 10a provided respectively in the first to fourth linear valves 7 to 10 are electrically connected with the brake ECU 100 via wire harnesses 90 to 96.

More specifically, electric power can be supplied to the board 80 from a power source 82 when a switch 81 is turned on. Further, the drive circuit in the brake ECU 100 and the solenoid coils 7a to 10a are connected such that the solenoid coils 7a to 10a are positioned between the power source 82 and the ground. NPN transistors 72 to 75 are provided in the lines that supply power to the solenoid coils 7a to 10a, respectively. More specifically, the NPN transistor 72 is provided between the power source 82 and the solenoid coil 7a. The NPN transistor 73 is provided between the power source 82 and the solenoid coil 8a. The NPN transistor 74 is provided between the solenoid coil 9a and the ground. The NPN transistor 75 is provided between the solenoid coil 10a and the ground. In addition, NPN transistors 62 to 65 are provided in parallel with the solenoid coils 7a to 10a. More specifically, the NPN transistor 62 is provided between the ground and a branching point 42 between the NPN transistor 72 and the solenoid coil 7a. The NPN transistor 63 is provided between the ground and a branching point 43 between the NPN transistor 73 and the solenoid coil 8a. The NPN transistor 64 is provided between the ground and a branching point 44 between the switch 81 and the solenoid coil 9a. The NPN transistor 65 is provided between the ground and a branching point 45 between the switch 81 and the solenoid coil 10a. A resistor 52 is provided between the branching point 42 and the NPN transistor 62. A resistor 53 is provided between the branching point 43 and the NPN transistor 63. A resister 54 is provided between the branching point 44 and the NPN transistor 64. A resister 55 is provided between the branching point 45 and the NPN transistor65. These NPN transistors 62 to 65 and 72 to 75 are switched on and off by a control unit (CPU) 71 provided in the brake ECU 100. The base current to each of these NPN transistors 72 to 75 is controlled by the CPU 71 so as to control the amperage of the control current applied to the solenoid coils 7a to 10a while the base currents to the NPN transistors 62 to 65 are set to OFF by the CPU 71. The above configuration is used to adjust the differential pressure generated by the first to fourth linear valves 7 to 10.

In cutting off the one or more of currents to the solenoid coils 7a to 10a, the CPU 71 sets the base current to corresponding one or more of the NPN transistors 62 to 65, 74, and 75 to ON and sets the base current to corresponding one or more of the NPN transistors 72 and 73 to OFF. Therefore, both ends of the one or more of the solenoid coils 7a to 10a are connected to the ground.

The above configuration also includes a mark unit 83 including a resistor 84 for indicating the characteristics, in other words, a similarity group of the differential pressure-current characteristics of the first to fourth linear valves 7 to 10. Further, a pull-down resistor 76 is provided between the input terminal of the CPU 71 and ground, whereby the potential between the resistor 84 and the pull-down resistor 76 is input to the CPU 71. As a result, the potential between the resistor 84 and the pull-down resistor 76 is varied in accordance with the resistance of the resistor 84. Accordingly, the CPU 71 is able to identify the characteristics of the first to fourth linear valves 7 to 10 indicated by the resistance of the resistor 84.

The vehicle brake control device shown in FIG. 1 is merely an example of the present invention. The vehicle brake control device of the present invention is not limited by that shown in FIG. 1, but may be modified in a variety of ways.

For example, in the first embodiment, examples were explained of vehicle brake control devices applied to a vehicle in which conduit systems include hydraulic circuits in an X conduit arrangement, with a conduit system connecting the left front and right rear wheels and another conduit system connecting the right front and left rear wheels. However, the present invention may also be applied to other systems, such as a front-and-rear conduit arrangement or the like.

In the above embodiments, the brake fluid is supplied to both the first conduit system and the second conduit system through the brake conduit C which is the only conduit connected with the master reservoir 3f. However, supplemental brake conduit other than the brake conduit C connected may be provided. In this case, the brake fluid may be supplied to the first conduit system through the brake conduit C and to the second conduit system through the supplemental brake conduit.

In the above embodiments, the M/C 3 is connected with the first conduit system and the second conduit system in case of the abnormal situation in which the first to four pumps 7 to 10 cannot generate pressure. In addition, in the above embodiments, the brake fluid is supplied from the master reservoir 3f during the normal braking. However, the operation is merely an example of the present invention. The M/C 3 may be separated from the first conduit system and the second conduit system. The M/C 3 may be disused. The brake fluid may be supplied not from the master reservoir 3f but from another reservoir which can store the brake fluid.

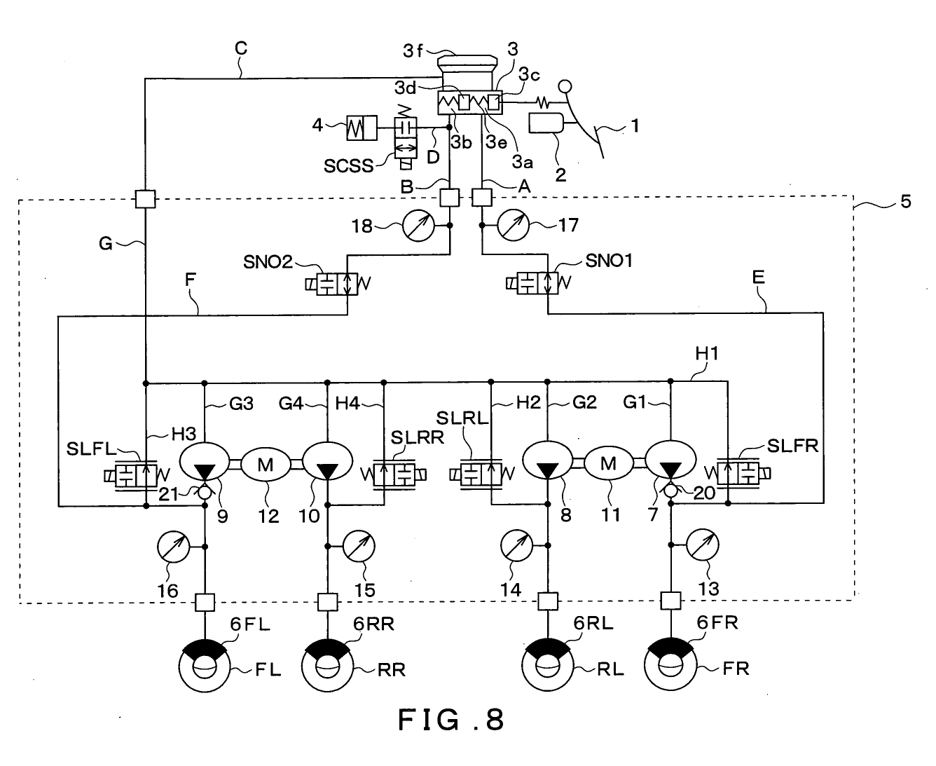

Also, in the preceding embodiments, even if the first to fourth linear valves SLFL to SLRR do not operate, the M/C pressure that is generated mechanically based on depressing of the brake pedal 1 is transmitted to the W/Cs 6FL, 6FR and the like in consideration of the need for fail-safe operation. However, if a location where an abnormality occurs is somewhere other than the first to fourth linear valves SLFL to SLRR, the first to fourth linear valves SLFL to SLRR can operate. So if electric power can be supplied to the first to fourth linear valves SLFL to SLRR so that the brake conduits H1 to H4 are closed (or, so that a pressure difference between an upstream and an downstream of each of the brake conduits H1 to H4 is maximized), it would be possible to transmit the M/C pressure to the W/Cs 6FL, 6FR and the like in the same manner as described above. Therefore, it is not necessarily the case that the first and second normally-closed valves SWC1, SWC2 or the single normally-closed valve SWC must be provided. As shown in the hydraulic circuit configuration shown in FIG. 8, a structure may also be used that is not provided with the first and second normally-closed valves SWC1, SWC2 or with the single normally-closed valve SWC.

However, in the sense that all fail-safe operations must be able to be executed mechanically, the first and second normally-closed valves SWC1 and SWC2 and the single normally-closed valve SWC are important.

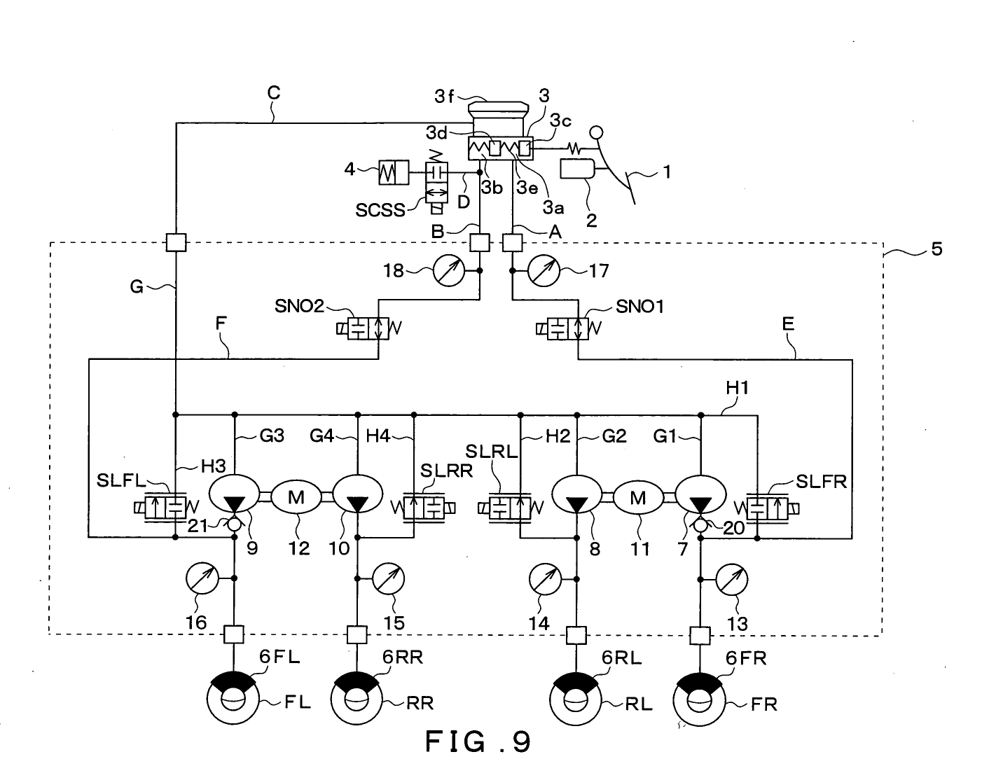

Therefore, as shown in the hydraulic circuit configuration shown in FIG. 9, it is more preferable if the first linear valve SLFR and the third linear valve SLFL are configured as normally-closed linear valves, because the fail-safe operation can be executed mechanically. Of course, the second linear valve SLRL and the fourth linear valve SLRR may also be configured as normally-closed linear valves.

In the above embodiments, the brake pedal 1 serves as an example of a brake operating member. However, a brake lever and the like may serve as and example of the brake operating member.

What is claimed is:

1. A vehicle brake control device, comprising:
a brake operating member to be operated by a driver;
an operation amount sensor for detecting an operation amount of the brake operating member;
a first and a second front wheel cylinder, which are respectively installed to two front wheels;
a first and a second rear wheel cylinder, which are respectively installed to two rear wheels;
a reservoir for storing brake fluid;
a main conduit for connecting the first and second front wheel cylinders and the first and second rear wheel cylinders with the reservoir, the main conduit branching into four sections which are respectively connected with the first and second front wheel cylinders and the first and second rear wheel cylinders;
a first pump located in a first one of the four sections, the first pump for pressurizing a first one of the first front wheel cylinder, the second front wheel cylinder, the first rear wheel cylinder, and the second rear wheel cylinder by drawing in and discharging the brake fluid stored in the reservoir;
a second pump located in a second one of the four sections, the second pump for pressurizing a second one of the first front wheel cylinder, the second front wheel cylinder, the first rear wheel cylinder, and the second rear wheel cylinder by drawing in and discharging the brake fluid stored in the reservoir;
a third pump located in a third one of the four sections, the third pump for pressurizing a third one of the first front wheel cylinder, the second front wheel cylinder, the first rear wheel cylinder, and the second rear wheel cylinder by drawing in and discharging the brake fluid stored in the reservoir;
a fourth pump located in a fourth one of the four sections, the fourth pump for pressurizing a fourth one of the first front wheel cylinder, the second front wheel cylinder, the first rear wheel cylinder, and the second rear wheel cylinder by drawing in and discharging the brake fluid stored in the reservoir;
a first motor for driving the first and second pumps which are provided to a first conduit system of the main conduit and pressurize the first conduit system;
a second motor for driving the third and fourth pumps which are provided to a second conduit system of the main conduit and pressurize the second conduit system;
first to fourth adjustment conduits, which are located respectively in parallel with the first to fourth pumps and return the brake fluid to the reservoir;
first to fourth linear valves, which are respectively located in the first to fourth adjustment conduits; and
a control means for controlling, based on a detection signal from the operation amount sensor, the first to fourth linear valves, the first motor, and the second motor,
wherein:
the control means includes:
a first calculating portion for calculating target wheel cylinder pressures corresponding to the operation amount detected by the operation amount sensor when the operation amount sensor detects that the brake operating member is operated;
a second calculating portion for calculating slip ratios of the front wheels and the rear wheels; and
an adjusting portion for adjusting current values of currents to be supplied to the first to fourth linear valves based on results of calculations of the first and second calculating portions; and
the adjusting portion includes a current cutting means for executing a fist current OFF control when one of the calculated slip ratios is larger than a first threshold value, the first current off control being for cutting off one of the currents for one of the first to fourth linear valves, the one linear valve corresponding to one of the front and rear wheels having the one slip ratio larger than the first threshold value.

2. The vehicle brake control device according to claim 1, wherein:
the control means includes a third calculating portion for calculating increase rates of the slip ratios calculated by, the second calculating portion; and
the current cutting means executes a second current OFF control when one of the calculated increase rates is larger than a second threshold value, the second current off control being for cutting off one of the currents for one of the first to fourth linear valves, the one linear valve corresponding to one of the front and rear wheels having the one increase rate larger than the second threshold value.

3. The vehicle brake control device according to claim 1, wherein the adjusting portion performs after executing the first current OFF control:
detecting wheel cylinder pressures of the first front wheel cylinder, the second front wheel cylinder, the first rear wheel cylinder, and the second rear wheel cylinder based on detection signals from pressure sensors for detecting respectively the wheel cylinder pressures; and
adjusting one of the current values for one of the linear valves which is under control of the first current OFF control, based on one of the detected wheel cylinder pressures corresponding to the one linear valve.

4. The vehicle brake control device according to claim 1, wherein the current cutting means executes the first current OFF control by connecting both ends of the one of the first to fourth liner valves with the ground.
